(19) United States
(12) Patent Application Publication
(10) Pub. No.: US 2003/0059582 A1
(43) Pub. Date: Mar. 27, 2003

(54) Corrugated pen holder

(76) Inventor: William Touzani, Houston, TX (US)

Correspondence Address: William Touzani, # H 14, 7575 Bellaire Rd., Houston, TX, 77036, US

(21) Appl. No.: 09/961,947

(22) Filed: Sep. 25, 2001

(51) Int. Cl. B32B 3/20

(52) U.S. Cl. 428/188

(57) ABSTRACT

The invention provides an improved pen holder in the form of a piece of corrugated plastic sheet, that can be cut to the desired size and glued to any flat surface. The clip of a pen penetrates the inside of a tubular chamber while the pen hangs on the outside.

The invention relates to pen holders made specifically from corrugated plastic sheets.

### BACKGROUND OF THE INVENTION

There is a variety of pen holders in the form of pouches, trays or bins available in the market today.

Pen holders are usually cumbersome and very visible. Anyone that needs a pen in an office environment can help him to the same pot. The problem is, a pen is never around when you need it.

The present invention provides a mean by which pens and pencils can be organized and hang side by side, in a streamlined position. The pen hanger of the invention is able to attach to any fixed or movable surface, in the most convenient areas, such as a computer monitor, telephone or the dashboard of a car.

### SUMMARY OF THE INVENTION

The invention provides an improved pen holder in the form of a piece of corrugated plastic sheet, that can be cut to the desired size and glued to any flat surface.

The clip of a pen is in the form of a stick that is parallel to the body of the pen, and is either an integral part of the pen or of the cap itself. This clip is normally designed to attach the pen to the pocket of a shirt.

The clip of a pen is approximately one inch in length, and can easily penetrate and lodge inside the tubular chamber of a corrugated strip or pad. The inwardly

### BRIEF DESCRIPTION OF THE DRAWINGS

FIG. 1 is a perspective view of a corrugated strip of plastic and a pen with the top surface partially uncovered.

FIG. 2 is a perspective view of a corrugated strip of plastic and a lid, with the top surface partially uncovered.

FIG. 3 is a side view of the pen clip inserted into a tubular chamber of a corrugated strip.

FIG. 4 is a side view of a stack of corrugated strips.

### DETAILED DESCRIPTION OF A PREFERED EMBODIMENT

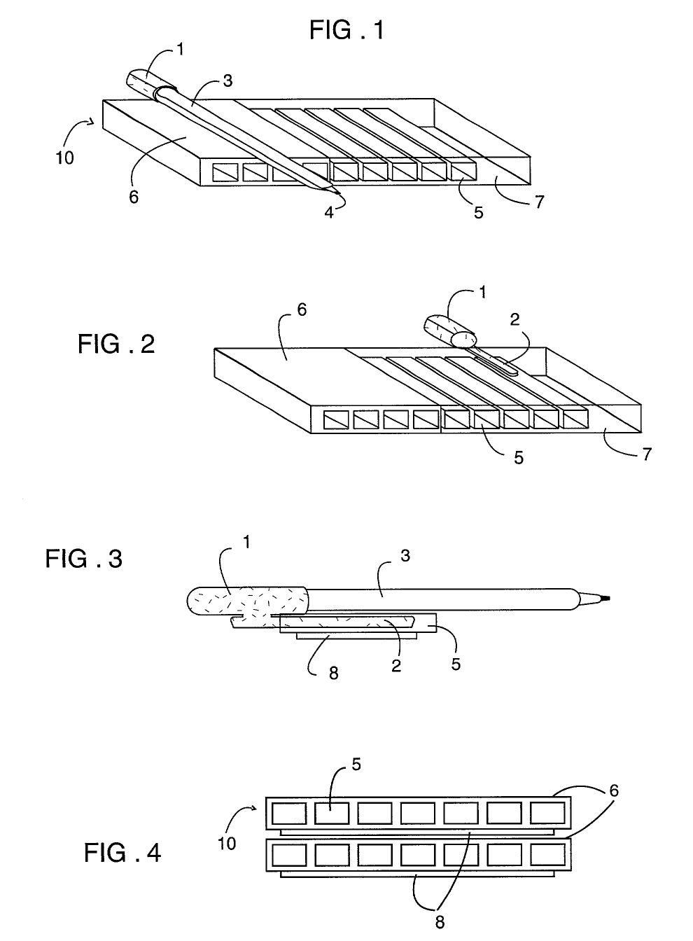

Referring to FIG. 1 and FIG. 2, a strip of corrugated plastic 10 is cut across its colons of tubular chambers 5 and limited by flat surfaces 6 and 7.

The pen includes body section 3, a cap 1 with an integral clip 2, and writing tip 4. Clip 2 is able to penetrate any of the corrugated chambers along the same longitudinal axis. Clip 2 and body 3 combine opposing pressure against flat surface 6 keeping the pen in position.

FIG. 3 is a side view of a pen 3 and cap 1 with integral clip 2 inserted into tunnel chamber 5. Adhesive layer 8 is fixed to the corrugated strip to make it stick to vertical or horizontal surfaces.

FIG. 4 shows a cross section of two strips or pads 10 and 11 of corrugated plastic with adhesive 8, stacked on top of each other. Adhesive layer 8 is resting directly over top surface 6 of the strip. Adhesive layer 8 can have an additional protective layer that peals off before the corrugated pad is applied to a surface. pressure provided by the clip against the outer wall surface of the strip will keep the pen in place.

Corrugated plastic sheets are widely used for indoors and outdoors signs, as support for printed advertising material, or for making packaging containers and boxes. The sheets are available in a variety of thickness and dimensions, and are made from polypropylene, PVC, acrylic or polycarbonate. The sheets are mostly hollow in the inside, as they are extruded into a succession of tubular chambers with flat outer surfaces.

The sheets of corrugated plastic can be cut across the tubular chambers into individual pieces. An adhesive layer is then applied to the top or bottom surface of the corrugated strip to allow them to stick to any flat surface.

Pieces of corrugated plastic with adhesive layer can then be sliced with scissors or cutters to the desired length before they are applied to a particular surface. The strips of corrugated plastic can be cut manually or mechanically to any shape or size, before they are packaged in piles, flat packages or rolls. The strips or pads of corrugated plastic can be glued to the desk walls or surface, to the computer monitor, or stapled to a book cover. Manufacturers can also include the corrugated strip with adhesive in the same package as pens, providing the consumer with immediate means of storage and display.

Other features of the invention will become apparent from the following detailed description of a preferred embodiment which, taken in conjunction with the accompanying drawings, illustrates by way of example the principles of the invention.

1. A portion of a flat sheet of corrugated plastic including several tubular chambers characterized in that, said tubular chambers, capable of receiving a pen clip.

2. A piece of corrugated plastic as described in claim 1, including one layer of adhesive material on at least one of its flat surfaces.

3. A piece of corrugated plastic material and pen clip combination, ready to hang on a flat surface.

4. A piece of corrugated plastic used as pen hanger, characterized in that inner tubular chambers are used to fit at least one pen clip.
